(19) United States
(12) Patent Application Publication
(10) Pub. No.: US 2016/0082844 A1
(43) Pub. Date: Mar. 24, 2016

(54) METHODS AND SYSTEMS FOR MULTIPLE SOURCE ENERGY STORAGE, MANAGEMENT, AND CONTROL

(71) Applicant: General Electric Company, Schenectady, NY (US)

(72) Inventors: Robert Dean King, Schenectady, NY (US); Funian Xiao, Houston, TX (US)

(21) Appl. No.: 14/494,205

(22) Filed: Sep. 23, 2014

(51) Int. Cl. B60L 11/18; H02M 3/158

(52) U.S. Cl. CPC B60L 11/18; H02M 3/158

(57) ABSTRACT

A direct current (DC) electric system includes a DC link, a first energy storage system (ESS), a second ESS, a coupling device, and a bidirectional DC-DC power converter. The first ESS is coupled to the DC link and stores energy for output at a first nominal voltage. The second ESS stores energy for output at a second nominal voltage greater than the first nominal voltage. A second ESS low side is coupled to a DC link low side. The coupling device is coupled between a second ESS high side and a DC link high side. The coupling device selectively transfers energy from the second ESS to the DC link. The bidirectional DC-DC power converter selectively transfers energy from the second ESS to the DC link and from the DC link to the second energy storage system.

### BACKGROUND

This description relates to energy storage systems, and more particularly, to systems and methods for multiple source energy storage, management, and control.

Electric vehicle systems and hybrid electric vehicles often use rechargeable batteries, either alone or in combination with a combustion engine, to provide electric power for vehicle propulsion. The batteries are connected to a direct current (DC) link which connects to a power control circuit such as a pulse width modulation (PWM) circuit for controlling power to a DC motor or to a frequency controlled inverter for controlling power to an alternating current (AC) motor. Alternatively, there may be multiple inverter/AC motor(s) in the electric system. The motor, either AC or DC, is coupled in driving relationship to one or more wheels of the vehicle, either in a direct drive arrangement or through an appropriate transmission. Some vehicles are hybrids and include small internal combustion engines which can be used to supplement battery power.

In the operation of an electric vehicle, the battery is often called upon to deliver short bursts of power at high current levels, typically during acceleration of the vehicle. When high current is drawn from conventional batteries, battery terminal voltage drops. One method for reducing the effect of high current requirements on electric drive system batteries is to use an auxiliary battery or passive energy storage device coupled to the DC link such that the device can provide additional power during high current situations. When two or more energy sources are used to provide power to the drive system, the energy sources may provide different types of power. A first energy source, for example, may be a high energy source that is more efficient at providing long-term power while a second energy source may be a high specific-power source more efficient at providing short-term power. The high specific-power source may be used to assist the high energy source in providing power to the system during, for example, acceleration or pulsed load events. Often, the high specific-energy source has a charge/discharge cycle life that is lower than the cycle life of the high power source.

### BRIEF DESCRIPTION

In one aspect, a direct current (DC) electric system is provided. The system is for use in providing DC power to a load via a DC link having a high side and a low side. The system includes a first energy storage system configured to store energy for output at a first nominal voltage. The first energy storage system is operatively connected to the DC link. A second energy storage system having a high side and a low side is configured to store energy for output at a second nominal voltage greater than the first nominal voltage. The second energy storage system low side is coupled to the DC link low side. A coupling device is coupled between the second energy storage system high side and the DC link high side. The coupling device is configured to selectively transfer energy from the second energy storage system to the DC link. A bidirectional DC-DC power converter is operatively connected to the DC link and the second energy storage system high side. The bidirectional DC-DC power converter is configured to selectively transfer energy from the second energy storage system to the DC link and from the DC link to the second energy storage system.

In another aspect, an electric propulsion system is provided. The electric propulsion system includes an electric drive system configured to propel an electric vehicle and a direct current (DC) electric system coupled to the electric drive system via a DC link having a high side and a low side. The DC electric system includes a first energy storage system operatively connected to the DC link. The first energy storage system includes a high specific energy battery. A second energy storage system has a high side and a low side and includes a high specific power battery. The second energy storage system low side is coupled to the DC link low side. A coupling device is coupled between the second energy storage system high side and the DC link high side. The coupling device is configured to selectively transfer energy from the second energy storage system to the DC link and selectively prevent electric current from flowing to the second energy storage system through the coupling device. A bidirectional DC-DC power converter is operatively connected to the DC link and the second energy storage system high side. The bidirectional DC-DC power converter is configured to selectively transfer energy from the second energy storage system to the DC link and from the DC link to the second energy storage system. A controller is communicatively coupled to the bidirectional DC-DC power converter. The controller is configured to control operation of the bidirectional DC-DC power converter to selectively transfer energy from the second energy storage system to the DC link to power the electric drive system and to selectively transfer energy from the DC link to the second energy storage system when the electric drive system produces regenerative power.

In a further aspect, a method for providing DC power to a load via a DC link is provided. The method includes delivering energy from a first energy storage system at a first voltage to the DC link, and delivering energy from a second energy storage system at a second voltage to the DC link via a coupling device when the second voltage is greater than or equal to the first voltage. The method further includes selectively delivering energy from the second energy storage system to the DC link via a bidirectional DC-DC power converter. The method also includes selectively delivering energy from the DC link to the second energy storage system via the bidirectional DC-DC power converter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagram of a direct current (DC) electric power system for use providing DC electric power to a load;

FIG. 2 is a block diagram of an exemplary computing device that may be used in the system in FIG. 1;

FIG. 3 is a simplified schematic diagram of an electric propulsion system including the DC electric power system shown in FIG. 1;

FIG. 4 is a simplified schematic diagram of another electric propulsion system including the DC electric power system shown in FIG. 1; and

FIG. 5 is a graph of simulated power delivery by the system shown in FIG. 1 to a load.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Embodiments of the present disclosure relate to energy storage systems. More particularly, embodiments of the present disclosure relate to systems and methods for multiple source energy storage, management, and control. Moreover, some embodiments relate to multiple source energy systems for providing energy to vehicular electric propulsion systems.

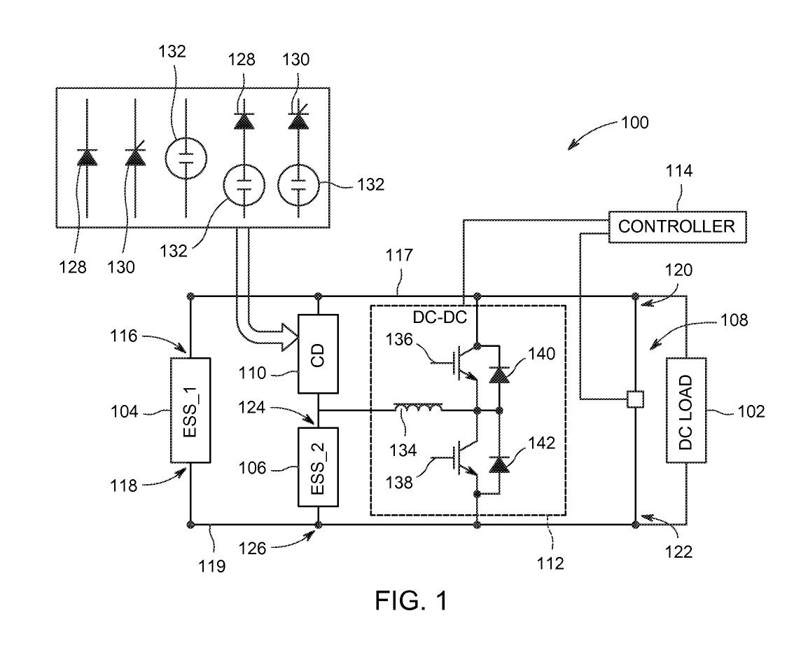

FIG. 1 is a diagram of a direct current (DC) electric power system, generally indicated by reference numeral 100, for use in providing DC electric power to a load 102. Load 102 may be an alternating current (AC) or direct current (DC) load, such as an electric traction motor for powering electric vehicles. Moreover, in some embodiments, load 102 includes a DC-AC inverter. System 100 includes a first energy storage system (ESS) 104 and a second ESS 106. First ESS 104 is coupled to load 102 via a DC link 108. In some embodiments, DC link 108 is a DC connection between two or more circuits (e.g., output of first ESS 104 and load 102), while in other embodiments, DC link 108 includes one or more components (e.g., a DC link capacitor). Second ESS 106 is selectively coupled to DC link 108 via a coupling device 110 and a bi-directional DC-DC power converter 112. Power converter 112 changes the voltage between an input and an output and does not change the power level between an input and an output. Accordingly, power converter 112 may sometimes be referred to as a voltage converter. A controller 114 monitors the voltage on DC link 108 and controls operation of power converter 112. Controller 114 may additionally monitor one or more parameters of first ESS 104 and/or second ESS 106 via each energy storage device's Battery Management System (BMS), not shown. These monitored battery parameters may include: State of Charge (SOC), terminal voltage, battery system temperature, battery cell(s) temperature, and State of Health (SoH).

First ESS 104 is a relatively high specific energy storage system including one or more energy storage devices (not separately illustrated) configured to store energy for output by first ESS 104 to load 102 at a first nominal voltage. Second ESS 106 is a relatively high specific power storage system including one or more energy storage devices (not separately illustrated) configured to store energy for output by second ESS 106 to load 102 at a second nominal voltage. The first nominal voltage of first ESS 104 is higher than the second nominal voltage of second ESS 106. In other embodiments, the first nominal voltage is about equal to the second nominal voltage. Moreover, in some embodiments, the first nominal voltage is less than the second nominal voltage by an amount approximately equal to a voltage drop across coupling device 110.

First ESS 104 is configured for a higher specific energy than second ESS 106 and a lower specific power than second ESS 106. In some embodiments, first ESS 104 has an energy density of between about 70 watt-hours per kilogram (W-hr/kg) and about 150 W-hr/kg. In other embodiments, first ESS 104 has an energy density on the order of approximately 100 W-hr/kg. In still other embodiments, first ESS 104 has an energy density greater than 150 W-hr/kg. First ESS 104 may also be a relatively high impedance, low specific power (e.g., between about 100 W/kg and about 250 W/kg) energy storage system. In some embodiments, first ESS 104 has an power density of about 200 W/kg or less. The energy storage device(s) of first ESS 104 can include combinations of one or more batteries, capacitors, ultracapacitors, or any other suitable energy storage device for producing an energy storage system having the desired high specific energy/low specific power characteristics. In an example embodiment, first ESS 104 includes one or more lithium ion batteries, lithium-air batteries, sodium metal halide batteries, sodium sulfur batteries, zinc air batteries, sodium-air batteries, or nickel metal hydride batteries.

Second ESS 106 is configured for a higher specific power than first ESS 104 and a lower specific energy than first ESS 104. Second ESS 106 has a specific power between about 275 W-kg and about 2500 W/kg. In some embodiments, second ESS 106 has a power density on the order of approximately 350 W/kg or greater. In other embodiments, second ESS 106 has a power density of greater than 2500 W/kg. In an exemplary embodiment, second ESS 106 includes one or more ultracapacitors (not separately shown). In some embodiments, the ultracapacitor has multiple capacitor cells, each of which has a capacitance greater than 500 farads. In some embodiments, the each ultracapacitor cell has a capacitance between about 500 and about 5000 farads. In other embodiments, the ultracapacitor(s) may have any suitable number of cells with any suitable capacitance to provide the desired power density, energy density, and/or nominal voltage. Alternatively, the energy storage device(s) of second ESS 106 can include combinations of one or more batteries, capacitors, ultracapacitors, or any other suitable energy storage device for producing an energy storage system having the desired high specific power characteristics. In some embodiments, second ESS 106 includes one or more lithium ion batteries, nickel metal hydride batteries, lithium titanate batteries, lead acid batteries, nickel cadmium batteries, and/or lithium nickel manganese cobalt oxide batteries.

First ESS 104 has a high side 116 coupled to a high side bus 117 and a low side 118 coupled to a low side bus 119. DC link 108 has a high side 120 coupled to high side bus 117 and a low side 122 coupled to low side bus 119. Second ESS 106 has a high side 124 coupled to coupling device 110 and power converter 112 and a low side 126 coupled to low side bus 119. First ESS 104 is operatively coupled to DC link 108 via high side bus 117 and low side bus 119. Second ESS 106 is coupled to DC link low side 122 via low side bus 119. The high sides of first ESS 104, second ESS 106, DC link 108, and high side bus 117 may also be referred to as a first side or a positive side. The low sides of first ESS 104, second ESS 106, DC link 108, and low side bus 119 may also be referred to as a second side or a negative side.

Coupling device 110 is coupled between high side 124 of second ESS 106 and the DC link high side 120 (via high side bus 117). Coupling device 110 is configured to selectively transfer or deliver energy from second ESS 106 to DC link 108 so that second ESS 106 can supplement the energy provided by first ESS 104. Moreover, coupling device 110 is configured to selectively prevent electric current from flowing to second ESS 106 through coupling device 110 (e.g., from first ESS 104, high side bus 117, and/or load 102). In an exemplary embodiment, coupling device 110 is configured to automatically (e.g., without human or controller 114 interaction), selectively transfer energy from second ESS 106 to DC link 108. In other embodiments, coupling device 110 is configured for at least partially controlled (e.g., by controller 114) selective transferring of energy from second ESS 106 to DC link 108. Coupling device 110 can include one or more of a diode 128, a silicon controlled rectifier (SCR) 130, and an electric contactor 132.

Automatic coupling devices 110 include, for example, diode 128. In coupling device 110, diode 128 is oriented with its cathode coupled to the DC link high side 120 (via high side bus 117) and its anode coupled to second ESS high side 124. When diode 128 is forward biased by the appropriate amount (e.g., when the voltage at high side 124 of second ESS 106 exceeds the voltage on high side bus 117 by a threshold voltage of the particular diode 128), current can flow from second ESS 106, through coupling device 110 to high side bus 117. When current is flowing from first ESS 104 to load 102, the voltage output by first ESS 104 will tend to decrease below its nominal voltage. Moreover, the voltage output by first ESS 104 will decrease as the amount of energy stored in ESS 104 decreases and the state of charge decreases. First ESS 104 has an initial operating voltage about the same or slightly higher than the nominal voltage of second ESS 106. Thus, when the voltage output of first ESS 104 decreases, the voltage on high side bus 117 will decrease below or within about a threshold voltage of diode 128 the voltage of second ESS 106 at high side 124 and coupling device 110 will be forward biased and diode 128 will begin conducting and will transfer energy from second ESS 106 to DC link 108.

Controlled, or partially controlled, coupling devices 110 may include, for example, SCR 130, electric contactor 132, or a series combination of contactor 132 and diode 128 or SCR 130. In embodiments in which coupling device 110 includes contactor 132, controller 114 is configured to open and close contactor 132 to selectively couple second ESS 106 to high side bus 117. In embodiments including SCR 130, controller 114 may be coupled to the gate of SCR 130 and configured to turn on (i.e., place in a conductive state) SCR 130 by providing a pulse to the gate of SCR 130. Some embodiments include a series connection of SCR 130 and contactor 132. Controller 114 is configured to turn on contactor 132 and SCR 130 (via a gate signal) to couple second ESS 106 to high side bus 117, and to decouple ESS 106 from high side bus 117 by opening contactor 132. Similarly, some embodiments include contactor 132 in series with diode 128. Controller 114 turns on contactor 132 and forward biasing of diode 128 automatically causes diode 128 to conduct. Controller 114 is configured to turn off or open contactor 132 to decouple second ESS from high side bus 119.

Bi-directional DC-DC power converter 112 is operatively connected to DC link 108 and second ESS high side 124. Power converter 112 is configured to selectively, under the control of controller 114, transfer energy from second ESS 106 to DC link 108 and from DC link 108 to second ESS 106. In the exemplary embodiment, bidirectional DC-DC power converter 112 is a buck-boost converter including an inductor 134, a first switch 136, a second switch 138, a first diode 140, and a second diode 142. In other embodiments, bidirectional DC-DC power converter 112 is any other suitable bidirectional power converter. When controller 114 desires to transfer energy from second ESS 106 to DC link 108 at a higher voltage than then current voltage of second ESS 106, controller 114 controls converter 112 as a boost converter to increase the voltage input from second ESS 106 to a higher output voltage at DC link 108. When load 102 is producing power, such as during regenerative breaking or overhauling load conditions, controller 114 can selectively transfer energy to second ESS 106 to recharge second ESS 106 by controlling converter 112 as a buck converter to reduce the voltage output by load 102 and couple the reduced voltage output to second ESS 106. Alternatively, controller 114 may control a DC-AC inverter and associated AC traction motor or load (not shown in FIG. 1) to control the DC link 108 voltage as well as the DC-DC converter 112, thereby allowing the regenerative braking energy or overhauling load to selectively transfer energy simultaneously to both first ESS 104 and second ESS 106. Controller 114 may select not to transfer energy from DC link 108 to second ESS 106, such as, without limitation, when there is a greater need for the energy to recharge first ESS 104 and when second ESS 106 is fully charged.

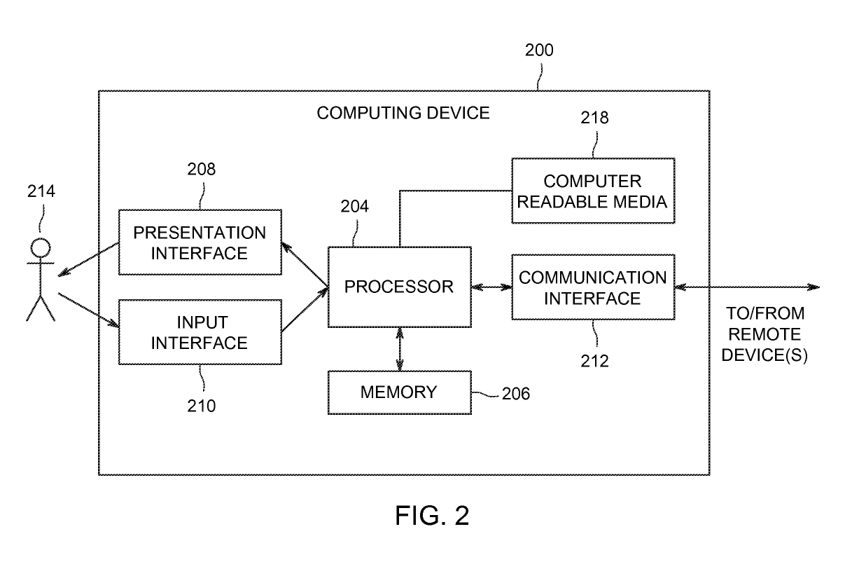

Controller 114 may include any suitable combination of analog and/or digital controllers capable of performing as described herein. In some embodiments, controller 114 includes a computing device. FIG. 2 is a block diagram of an exemplary computing device 200 that may be used in system 100. In the exemplary embodiment, computing device 200 includes a memory 206 and a processor 204 that is coupled to memory 206 for executing programmed instructions. Processor 204 may include one or more processing units (e.g., in a multi-core configuration). Computing device 200 is programmable to perform one or more operations described herein by programming memory 206 and/or processor 204. For example, processor 204 may be programmed by encoding an operation as one or more executable instructions and providing the executable instructions in memory device 206. The executable instructions, when executed by processor 204, cause processor 204 to perform the operations encoded therein.

Processor 204 may include, but is not limited to, a general purpose central processing unit (CPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by processor 204, cause processor 204 to perform at least a portion of the methods described herein. The above examples are exemplary only, and thus are not intended to limit in any way the definition and/or meaning of the term processor.

Memory device 206, as described herein, is one or more devices that enable information such as executable instructions and/or other data to be stored and retrieved. Memory device 206 may include one or more computer-readable media, such as, without limitation, dynamic random access memory (DRAM), static random access memory (SRAM), a solid state disk, and/or a hard disk. Memory device 206 may be configured to store, without limitation, maintenance event log, diagnostic entries, fault messages, and/or any other type of data suitable for use with the methods and systems described herein.

In the illustrated embodiment, computing device 200 includes a presentation interface 208 that is coupled to processor 204. Presentation interface 208 outputs (e.g., display, print, and/or otherwise output) information such as, but not limited to, installation data, configuration data, test data, error messages, and/or any other type of data to a user 214. For example, presentation interface 208 may include a display adapter (not shown in FIG. 2) that is coupled to a display device, such as a cathode ray tube (CRT), a liquid crystal display (LCD), a light-emitting diode (LED) display, an organic LED (OLED) display, and/or an “electronic ink” display. In some implementations, presentation interface 208 includes more than one display device. In addition, or in the alternative, presentation interface 208 may include a printer. In other embodiments, computing device does not include presentation interface 208 and/or is not coupled to a display device.

In the exemplary embodiment, computing device 200 includes an input interface 210 that receives input from user 214. For example, input interface 210 may be configured to receive selections, requests, credentials, and/or any other type of inputs from user 214 suitable for use with the methods and systems described herein. In the exemplary implementation, input interface 210 is coupled to processor 204 and may include, for example, a keyboard, a card reader (e.g., a smartcard reader), a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of presentation interface 208 and as input interface 210. In other embodiments, computing device does not include input interface 210.

In the exemplary embodiment, computing device 200 includes a communication interface 212 coupled to memory 206 and/or processor 204. Communication interface 212 is coupled in communication with one or more remote device, such as another computing device 200, a remote sensor, a detection instrument, etc. Moreover, communication interface 212 may be coupled in communication with a device or component to be controlled by computing device 200, such as, without limitation, power converter 112, switches 136 and 138, and load 102. Communication interface 212 may include, without limitation, a wired network adapter, a wireless network adapter, an input/output port, analog to digital input/output port, and a mobile telecommunications adapter. Although a single communication interface 212 is shown in FIG. 2, in other embodiments, computing device 200 includes more than one communication interface 212.

Instructions for operating systems and applications are located in a functional form on non-transitory memory 206 for execution by processor 204 to perform one or more of the processes described herein. These instructions in the different implementations may be embodied on different physical or tangible computer-readable media, such as memory 206 or another memory, such as a computer-readable media 218, which may include, without limitation, a flash drive, CD-ROM, thumb drive, floppy disk, etc. Further, instructions are located in a functional form on non-transitory computer-readable media 218, which may include, without limitation, a flash drive, CD-ROM, thumb drive, floppy disk, etc. Computer-readable media 218 is selectively insertable and/or removable from computing device 200 to permit access and/or execution by processor 204. In one example, computer-readable media 218 includes an optical or magnetic disc that is inserted or placed into a CD/DVD drive or other device associated with memory 206 and/or processor 204. In some instances, computer-readable media 218 may not be removable.

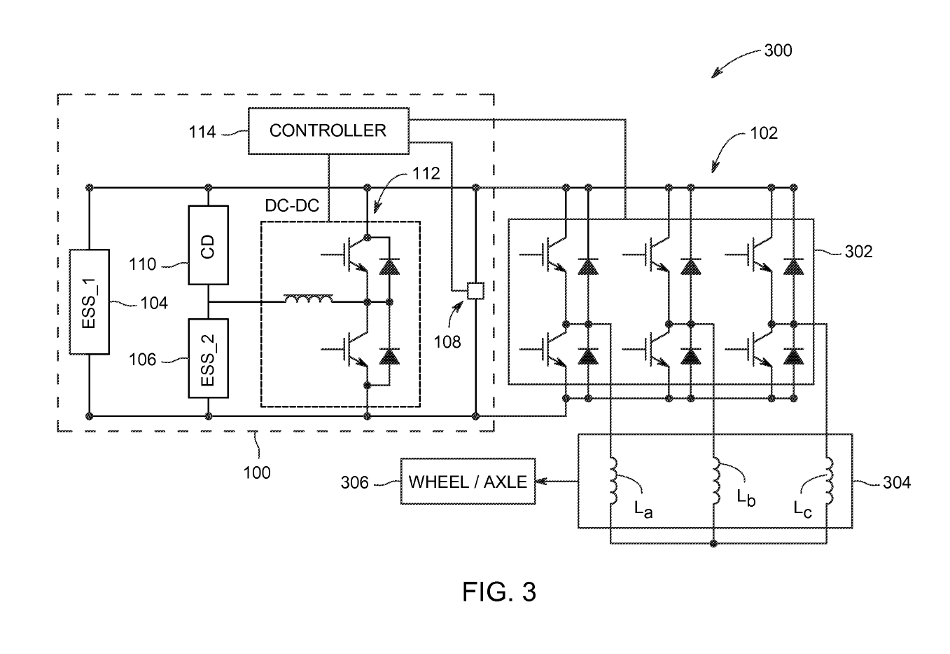

FIG. 3 is a simplified schematic diagram of an electric propulsion system 300 including DC electric power system 100. Electric propulsion system 300 may be a purely electric propulsion system or a hybrid-electric propulsion system. In system 300, DC load 102 includes a multiple phase, (typically three phase as illustrated in FIG. 3) inverter 302 and a traction motor 304 coupled to a wheel 306. Although illustrated connected directly to wheel 306, motor 304 may be operatively coupled to wheel 306 via, without limitation, a transmission, one or more gears, a transaxle, and a differential. Controller 114 selectively, such as in response to a power or torque command from a throttle, controls operation of inverter 302 to deliver energy from DC link 108 to motor 304 to drive wheel 306 to propel the vehicle (not shown) in which system 300 is installed. In other embodiments, a different controller (not shown) controls inverter 302. During coasting, braking, and other overhauling load conditions, wheel 306 drives motor 304, which acts as a generator and produces a power output that is coupled, via inverter 302, to DC link 108.

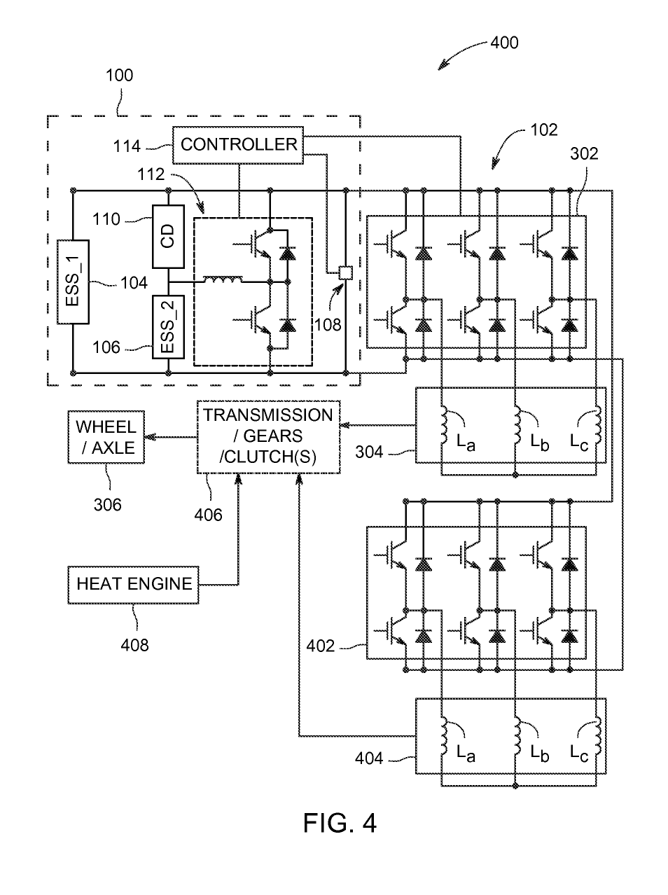

FIG. 4 is a simplified schematic diagram of an electric propulsion system 400 for a hybrid electric vehicle (not shown) including DC electric power system 100. In system 400, DC load 102 includes three phase DC-AC inverter 302 coupled to an AC traction motor 304. System 400 also includes a three phase DC-AC inverter 402 coupled to alternator motor 404. Motors 304 and 404 are coupled to gear system 406, which is operatively coupled to wheel 306. Motors 304 and 404 are designed to operate at both positive and negative torque levels as well as both clockwise and counterclockwise direction of rotation. In an exemplary embodiment, gear system 406 is a planetary gear system. Alternatively, gear system 406 may be any other gear system suitable for driving wheel 406. System 400 includes a heat engine 408. Heat engine 408 may be a gasoline combustion engine, a diesel engine, a steam engine, or any other suitable internal or external combustion heat engine. Controller 114 selectively, such as in response to a power or torque command from a throttle, controls operation of inverter 302 to deliver energy from DC link 108 to motor 304 to drive wheel 306 to propel the vehicle (not shown) in which system 300 is installed. Controller 114 also selectively controls operation of inverter 402 to deliver energy from DC link 108 to motor 404 to crank (i.e., start) heat engine 408 and/or drive wheel 306. In other embodiments, a different controller (not shown) controls inverters 302 and/or 402. During coasting, braking, and other overhauling load conditions, wheel 306 drives motors 304 and/or 404, which act as generators and produces a power output that is coupled, via inverters 302 and/or 402, to DC link 108.

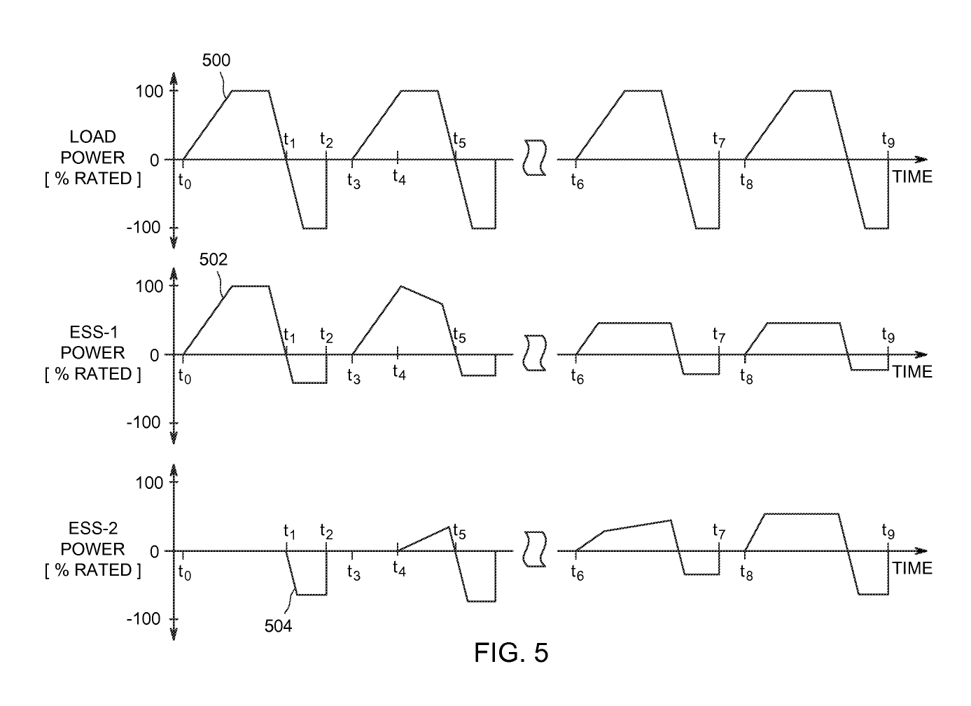

FIG. 5 is a graph of simulated power delivery by system 100 to DC load 102 (both shown in FIG. 1). Trace 500 is the power, as a percentage of rated power, that is delivered to load 102 over time. Trace 502 is the power provided and received by first ESS 104 (shown in FIG. 1). Trace 504 is the power provided and received by second ESS 106 (shown in FIG. 1). From time t0 to time t1, power is delivered to load 102 from first ESS 104 and second ESS 106 does not provide any power to load 102. From time t1 to t2, load 102 is producing power (i.e., it has a negative power consumption, often referred to as operating in a regenerative braking mode). A portion of the power is delivered to first ESS 104 and a portion is delivered (through converter 112 (shown in FIG. 1)) to second ESS 106. From time t3 to t4, power is delivered to load 102 from first ESS 104. From time t4 to time t5, first ESS 104 is unable to provide all of the power required by load 102 and a portion of the load power is provided by second ESS 106 (through coupling device 110 (shown in FIG. 1) and/or power converter 112). The power cycles occurring between time t6 to t7 and t8 to t9 occur at a later time than the cycles occurring between time t0 and t5. The state of charge of first ESS 104 is lower than it was earlier and first ESS 104 is able to provide less of the power demanded by load 102. A greater portion of the power delivered to load 102 comes from second ESS 106.

The exemplary electric power systems and methods described herein provide reliable, balanced, low cost, multisource electric systems for powering loads. The systems provide increased efficiency over some known systems due to reduced power demands on the first energy storage system and improved energy utilization. Embodiments may increase the life of the first energy storage system versus some known systems by decreasing the peak power demanded from the first energy storage system. Moreover, the example systems may provide improved DC link voltage control, especially during discharging operation when the first energy storage system is at a relatively low state of charge. The use of the coupling device plus bidirectional power converter to boost the output voltage of the second energy storage system allows the use of lower power rated devices in the bidirectional power converter, compared to a system without a coupling device. Furthermore, high power regenerative energy capture from the overhauling load to the second ESS typically occurs at higher voltage levels, thus requiring lower current values and thus lower cost power converter.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, the system may also be used in combination with other apparatus, systems, and methods, and is not limited to practice with only the system as described herein. Rather, the exemplary embodiment can be implemented and utilized in connection with many other applications. Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A direct current (DC) electric system for use in providing DC power to a load via a DC link, said system comprising:
a DC link comprising a high side and a low side;
a first energy storage system configured to store energy for output at a first nominal voltage, said first energy storage system operatively connected to said DC link;
a second energy storage system configured to store energy for output at a second nominal voltage less than the first nominal voltage, said second energy storage system comprising a high side and a low side, said second energy storage system low side coupled to said DC link low side;
a coupling device coupled between said second energy storage system high side and said DC link high side, said coupling device configured to selectively transfer energy from said second energy storage system to said DC link; and
a bidirectional DC-DC power converter operatively coupled to said DC link and said second energy storage system high side, said bidirectional DC-DC power converter configured to selectively transfer energy from said second energy storage system to said DC link and from said DC link to said second energy storage system.

2. The DC electric system in accordance with claim 1, further comprising a controller, said controller operatively coupled to said bidirectional DC-DC power converter and configured to operate said DC-DC power converter to selectively transfer energy from said second energy storage system to said DC link and from said DC link to said second energy storage system.

3. The DC electric system in accordance with claim 1, further comprising a controller, said controller operatively coupled to said coupling device and configured to operate said coupling device to selectively transfer energy from said second energy storage system to said DC link.

4. The DC electric system in accordance with claim 3, wherein said controller is configured to selectively operate said bidirectional DC-DC power converter as a boost converter to transfer energy from said second energy storage system to said DC link and as a buck converter to transfer energy from said DC link to said second energy storage system.

5. The DC electric system in accordance with claim 1, wherein said first energy storage system comprises a high specific energy device and said second energy storage system comprises a high specific power device.

6. The DC electric system in accordance with claim 1, wherein said second energy storage system comprises at least one of a high specific power battery, an ultracapacitor, and a combination of a high specific power battery and an ultracapacitor.

7. The DC electric system in accordance with claim 1, wherein said coupling device comprises a diode including a cathode coupled to said DC link high side and an anode coupled to said second energy storage system high side.

8. The DC electric system in accordance with claim 7, further comprising a contactor coupled in series with said diode.

9. The DC electric system in accordance with claim 1, wherein said coupling device comprises a silicon controlled rectifier (SCR), said SCR including a cathode coupled to said DC link high side and an anode coupled to said second energy storage system high side.

10. The DC electric system in accordance with claim 9, wherein said coupling device further comprises a contactor coupled in series with said SCR.

11. An electric propulsion system for use to propel an electric vehicle, said electric propulsion system comprising:
an electric drive system;
a direct current (DC) electric system coupled to said electric drive system via a DC link comprising a high side and a low side, said DC electric system comprising:
a first energy storage system operatively connected to the DC link, said first energy storage system comprising a high specific energy battery;
a second energy storage system comprising a high side and a low side and comprising a high specific power battery, said second energy storage system low side coupled to said DC link low side;
a coupling device coupled between said second energy storage system high side and said DC link high side, said coupling device configured to selectively transfer energy from said second energy storage system to said DC link and selectively prevent electric current from flowing to said second energy storage system through said coupling device;
a bidirectional DC-DC power converter operatively coupled to said DC link and said second energy storage system high side, said bidirectional DC-DC power converter configured to selectively transfer energy from said second energy storage system to said DC link and from said DC link to said second energy storage system; and
a controller communicatively coupled to said bidirectional DC-DC power converter, said controller configured to control operation of said bidirectional DC-DC power converter to selectively transfer energy from said second energy storage system to said DC link to power said electric drive system and to selectively transfer energy from said DC link to said second energy storage system when said electric drive system produces regenerative power.

12. The electric propulsion system in accordance with claim 11, wherein said first energy storage system comprises one of a sodium-metal halide battery, a sodium sulfur battery, a zinc-air battery, a sodium-air battery, a lithium-ion battery, a lithium-air battery, and a nickel metal hydride battery.

13. The electric propulsion system in accordance with claim 11, wherein said second energy storage system comprises at least one of a high specific power battery and an ultracapacitor.

14. The electric propulsion system in accordance with claim 13, wherein said high specific power battery comprises one of a lithium ion battery, a nickel metal hydride battery, a lithium titanate battery, a lead acid battery, a nickel cadmium battery, and a lithium nickel manganese cobalt oxide battery.

15. The electric propulsion system in accordance with claim 11, wherein said coupling device comprises at least one of a diode, a silicon controlled rectifier (SCR), and a contactor.

16. The electric propulsion system in accordance with claim 11, wherein said bi-directional DC-DC power converter comprises a buck-boost converter, and wherein said controller is configured to:
selectively control operation of said bidirectional DC-DC power converter as a boost converter to transfer energy from said second energy storage system to said DC link to power said electric drive system; and
selectively control operation of said bidirectional DC-DC power converter as a buck converter to transfer energy from said DC link to said second energy storage system when said electric drive system produces regenerative power.

17. A method for providing DC power to a load via a DC link, said method comprising:
delivering energy from a first energy storage system at a first voltage to the DC link;
delivering energy from a second energy storage system at a second voltage to the DC link via a coupling device when the second voltage is greater than or equal to the first voltage;
selectively delivering energy from the second energy storage system to the DC link via a bidirectional DC-DC power converter; and
selectively delivering energy from the DC link to the second energy storage system via the bidirectional DC-DC power converter.

18. The method in accordance with claim 17, wherein selectively delivering energy from the DC link to the second energy storage system via the bidirectional DC-DC power converter comprises selectively operating the bidirectional DC-DC power converter as a buck converter when load is generating power and the DC link is at a third voltage greater than the second voltage.

19. The method in accordance with claim 17, wherein selectively delivering energy from the second energy storage system to the DC link via a bidirectional DC-DC power converter comprises selectively operating the bidirectional DC-DC power converter as a boost converter.

20. The method in accordance with claim 17, wherein delivering energy from a second energy storage system at a second voltage to the DC link via a coupling device when the second voltage is greater than the first voltage comprises delivering energy from a second energy storage system at the second voltage to the DC link via at least one of a diode, a silicon controlled rectifier, and a contactor.
